(19) United States
(12) Patent Application Publication
(10) Pub. No.: US 2015/0091284 A1
(43) Pub. Date: Apr. 2, 2015

(54) Device and method for activating an air bag for a vehicle and an air bag system for a vehicle

(71) Applicants: Leonardo KOVACIC, Vaihingen Enz (DE); Werner Nitschke, Asperg (DE); Hartmut Schumacher, Freiberg (DE); Ruediger Karner, Kornwestheim (DE)

(72) Inventors: Leonardo KOVACIC, Vaihingen Enz (DE); Werner Nitschke, Asperg (DE); Hartmut Schumacher, Freiberg (DE); Ruediger Karner, Kornwestheim (DE)

(73) Assignee: Robert Bosch GmbH, Stuttgart (DE)

(21) Appl. No.: 14/501,357

(22) Filed: Sep. 30, 2014

(30) Foreign Application Priority Data
Oct. 1, 2013 (DE) 10 2013 219 905.8

(51) Int. Cl. B60R 21/261; B60R 21/274

(52) U.S. Cl. CPC B60R 21/261; B60R 21/274; B60R 2021/26094
USPC 280/737

(57) ABSTRACT

A device for activating an air bag for a vehicle, the device having a pressure vessel for supplying a gas under pressure using at least one exit opening for letting out a first volume flow of the gas to the air bag, a valve element connected to the pressure vessel, which is configured to close the exit opening at least partially in a resting position and, in a motion into a triggering position, to release the exit opening, and a bursting element for the gas-tight closing of the pressure vessel. The device further includes a bypass region for letting out a second volume flow of the gas to the air bag, the bypass region being situated before an end region of the exit opening in relation to the main flow direction of the first volume flow.

### RELATED APPLICATION INFORMATION

The present application claims priority to and the benefit of German patent application no. 10 2013 219 905.8, which was filed in Germany on Oct. 1, 2013, the disclosure of which is incorporated herein by reference.

### FIELD OF THE INVENTION

The present invention relates to a device and a method for activating an air bag for a vehicle, an air bag system for a vehicle, to a corresponding control unit as well as a corresponding computer program product.

### BACKGROUND INFORMATION

The safety requirements for air bag components in the automotive field are high and correspond to the standard ISO 26262 and the related art. Each new method for actuating air bag components is subject to these specifications. Thus, it has to be insured that, on the one hand, an individual error does not cause an undesired air bag ignition and, on the other hand, an individual error does not prevent the unfolding of the air bag.

### SUMMARY OF THE INVENTION

With this as background, the present invention introduces a device for activating an air bag for a vehicle, an air bag system for a vehicle, a method for activating an air bag for a vehicle, furthermore a control unit which uses this method, and finally a corresponding computer program product in accordance with the main claims. Advantageous refinements are derived from the respective dependent claims and from the following description.

A minimum filling of the air bag is made possible by using the integration of a bypass region in a valve of a gas generator for an air bag, independently of the functioning of the valve. According to the concept presented here, the valve-controlled gas generator is able to be improved in such a way that, in the case of a malfunction of a regulating unit of the valve control or a fault in the valve ignition circuit, a minimum filling of the air bag can be achieved, which in its effect is comparable to the second pyrotechnical stage of the gas generator.

Using the concept presented here, valve-controlled retaining components may be further improved based on the better adaptive adjustment to the crash situation, not only functionally but also with respect to safety technology. Maintaining the existing safety requirements for air bag components may thus be ensured beyond the measure already known.

A device for activating an air bag for a vehicle having a pressure vessel, for supplying a gas under pressure, using at least one exit opening for letting out a first volume flow of the gas to the air bag, a valve element connected to the pressure vessel, which is configured to close at least partially the exit opening in a resting position, and in one movement into a triggering position to release the exit opening, and a bursting element that is connected upstream with relation to the main flow direction of the first volume flow of the exit opening, for the gas-tight closing of the pressure vessel, moreover has the following feature:

a bypass region for letting out a second volume flow of the gas to the air bag, the bypass region, in relation to the main flow direction of the first volume flow, being situated before an end region of the exit opening.

The device may be used, for example, in a road-bound vehicle, such as a passenger car or a truck, in connection with an air bag of the vehicle. Among other things, its use in the case of a collision of the vehicle is able to improve the functional safety of the air bag by introducing an additional safety step. The pressure vessel may also be designated and configured as a gas generator, in order safely to enclose the gas used to fill up the air bag up to the point of the activation of the air bag. The pressure vessel may have the shape of an elongated cylinder, whose one end may be connected to the valve element or is able to form a valve region having the valve element. The valve region may be formed in one piece with the pressure vessel or may represent a valve which has been rigidly connected to the pressure vessel in the production process, so that gas is able to flow out from the pressure vessel-valve combination only at the regions of the exit opening and the bypass region provided for this. The exit opening may be situated in the form of a feed-through opening in a wall of the pressure vessel.

The pressure vessel may also have a plurality of exit openings. The exit opening may be connected to the air bag and be configured to guide the first volume flow of the gas, rapidly and free from loss, from the pressure vessel to the air bag, so that it is able to be inflated, for instance, in a controlled manner with the cooperation of the valve element. The valve element may be configured in the form of a piston, which is able to be moved in the valve region of the device, along a longitudinal extension of the device between the resting position and the triggering position. The gas may be a cold gas. The main flow direction of the volume flow may run essentially from the pressure vessel to the valve element. The bursting element may be configured to close the pressure vessel in a manner of a cover, and to be destroyed in the case of a collision in a simple and rapid manner, so that the gas is able to flow from the pressure vessel and get to the air bag through the exit opening or the bypass region into the air bag, in order to inflate it. Besides the exit opening, the bypass region may provide a further exit possibility for the gas into the air bag, which is able to be used independently of a functionality of the valve element. In this context, the bypass region may partially overlap with the exit opening or may be connected upstream of it, at a distance from the exit opening. By end region of the exit opening one may understand a distal wall of the exit opening, with respect to the position of the bursting element.

According to one specific embodiment of the device, the bypass region may be configured to effect that the second volume flow be smaller than the first volume flow. In that way, a gentle inflating of the air bag or a fine control of the air bag volume is able to be ensured advantageously.

Furthermore, the bypass region may be configured to have the effect that the second volume flow corresponds to an outlet volume flow of the gas through at least one disposal opening of the airbag for disposing of the gas from the air bag. Thus, a filling state of the air bag is able to be maintained in a simple manner for a predetermined time during or after a collision, independently of a functionality of the valve element. Consequently, a possible malfunction of the valve element control also does not impair the protective function of the air bag, or only slightly.

According to one additional specific embodiment, the bypass region is able to be formed by at least one additional exit opening in the pressure vessel. In this context, the distance of the additional exit opening from the bursting element may be less than the distance of the valve element from the bursting element in the resting position of the valve element. By using an additional exit opening, the magnitude of the second volume flow is able to be measured very accurately, and consequently the fine regulation of the air bag volume is advantageously able to be regulated exactly.

Alternatively, the bypass region may be formed by a tapered section of the valve element, the tapered section being able to lie totally or partially essentially at the same height of the exit opening, in the resting position of the valve element. In this context, in particular, the resting position is able to lie within a tolerance range of 5% or 10% (in relation to the overall length of the valve element) at the same height as the exit opening. Thus, the second volume flow may be regulated even more exactly, under certain circumstances, by taking into account a motion of the valve element between the resting position and the triggering position.

In one further alternative specific embodiment, the bypass region may be formed by a gradation of the valve element lowering a cross section of the valve element, the gradation being essentially able to lie at the same height of the exit opening in the resting position of the valve element. In this context, in particular, the resting position is able to lie within a tolerance range of 5% or 10% (in relation to the overall length of the valve element) at the same height as the exit opening. Using this specific embodiment of the device, too, the second volume flow is able to be regulated especially accurately by possibly taking into account a motion of the valve element between the resting position and the triggering position, the valve element being also able to be produced especially simply and cost-effectively, in this form.

An air bag system for a vehicle has the following features: a device for activating an air bag according to one of the specific embodiments described above; and an air bag which is connected to the device in such a way that, based on a destruction of the bursting element, the air bag is filled with the gas via the exit opening and/or the bypass region. In this context, the greater first gas volume flow is able to flow into the air bag via the exit opening, and the lesser second gas volume flow via the bypass region. This may, at least partially, occur simultaneously, upon the destruction of the bursting element, the gas flow through the exit opening being, at least phase-wise, able to be interrupted by periodic closing of the valve region, for example, while the gas flow through the bypass region is able to be uninterrupted right up to the emptying of the pressure vessel. Consequently, on the one hand, the complete emptying of the pressure vessel until the arrival of rescue forces may be ensured and, on the other hand, so may a continued filling or partial filling of the air bag during the course of the collision, independently of a possible malfunction of the valve.

A method for activating an air bag for a vehicle, in which the method is carried out using a device which has a pressure vessel for supplying a gas that is under pressure using at least one exit opening for letting out a first volume flow of the gas to the air bag, a valve element connected to the pressure vessel, which is configured to close the exit opening at least partially in a resting position and in a motion into the triggering position to release the exit opening, a bursting element that is connected upstream of the exit opening in relation to the main flow direction of the first volume flow, for the gas-tight closing of the pressure vessel and a bypass region for letting out a second volume flow of the gas to the air bag, the bypass region being situated before an end region of the exit opening, in relation to the main flow direction of the first volume flow having the following step:

Emitting an ignition signal for destroying the bursting element, in order to fill the air bag with gas via the exit opening and/or the bypass region.

The method may be useful for being carried out or implemented by a control unit connected to a device, described in this document, in one of the specific embodiments described above. The object on which the present invention is based is also able to be attained quickly and efficiently by this embodiment variant of the present invention in the form of a method.

Furthermore, a control unit is presently also provided which has at least one unit that is configured to carry out the step of a method provided here.

In the case at hand, by a control one may understand an electrical unit which processes sensor signals and outputs control signals and/or data signals as a function thereof. The control device may have an interface, which may be configured as hardware and/or software. In a hardware configuration, the interfaces, for example, may be part of a so-called system ASIC, which includes all kinds of functions of the control unit. However, it is also possible for the interfaces to be self-contained, integrated switching circuits or to be at least partially made up of discrete components. In a configuration as software, the interfaces may be software modules which are present on a microcontroller in addition to other software modules, for example.

Also advantageous is a computer program product which has program code that may be stored on a machine-readable carrier such as a semiconductor memory, a hard-disk memory or an optical memory, and which is able to be used to implement the method according to one of the specific embodiments described above, when the program product is run on a computer or a device.

In the following text, the present invention will be explained in greater detail by way of example with reference to the attached drawings.

### BRIEF DESCRIPTION OF THE DRAWINGS

FIG. 1 shows a longitudinal sectional representation of a servo valve having a bursting disk, according to the related art.

FIG. 2 shows a basic representation of an air bag system for a vehicle according to an exemplary embodiment of the present invention.

FIG. 3 shows a longitudinal sectional representation of a section of a device for activating an air bag for a vehicle, according to an exemplary embodiment of the present invention.

FIG. 4 shows a longitudinal sectional representation of a section of a device for activating an air bag for a vehicle, according to a further exemplary embodiment of the present invention.

FIG. 5 shows a longitudinal sectional representation of a section of a device for activating an air bag for a vehicle, according to a further exemplary embodiment of the present invention.

FIG. 6 shows a diagram to illustrate the pressure curve in a can test of a device for activating an air bag for a vehicle, according to an exemplary embodiment of the present invention.

FIG. 7 shows a flow chart of a method for activating an air bag for a vehicle, according to an exemplary embodiment of the present invention.

### DETAILED DESCRIPTION

In the following description of exemplary embodiments of the present invention, identical or similar reference numerals are used for similarly acting elements shown in the various figures, a repeated description of these elements being omitted.

Valve-controlled adaptive gas generators for activating air bags in vehicles have to correspond to the same safety standards as conventional gas generators which are used in 2-step or multi-step air bags.

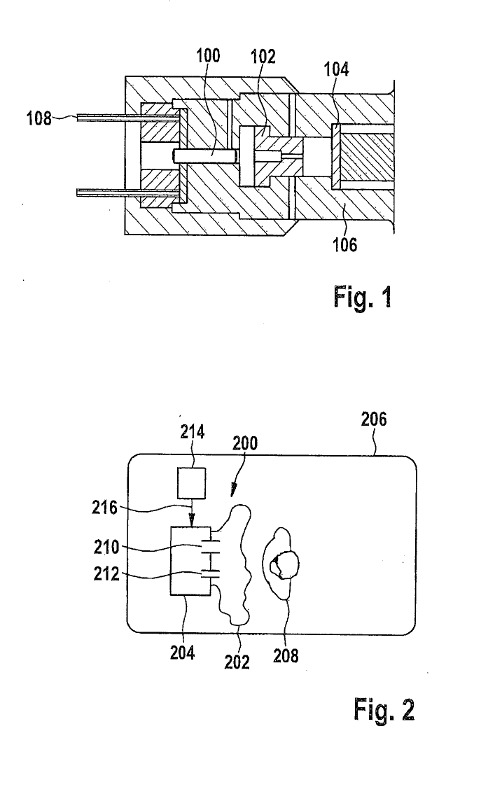

FIG. 1 shows a servo valve 100 for a gas generator of an air bag, according to the related art, in longitudinal section. A servo valve 100 is a continuously operated valve in which the flow rate is able to be set by a motion of a control piston 102 in the valve housing, in a stepless manner. Upon the destruction of the bursting disk 104, a gas flow to be regulated by servo valve 100 is liberated from a pressure vessel 106 of the gas generator.

In order for gas generators to remain gas-tight over the entire life of a vehicle, in having bursting disk 104 they have a material separation between pressure vessel 106 and a gas exit 108 into the air bag. Bursting disk 104 is opened via a separate ignition circuit (not shown). This applies both for the related art and for the valve-controlled adaptive gas generators in the development stage. Valve 100 following bursting disk 104 receives an additional ignition circuit (also not shown). After the opening of bursting disk 104, valve 100 is actuated; it controls the volume flow of the gas.

FIG. 2 is a basic representation of an air bag system for a vehicle, according to an exemplary embodiment of the present invention;

An air bag system for a vehicle, the air bag system having the following features:
a device for activating an air bag according to one of the description herein; and
an air bag which is connected to the device in such a way that, based on a destruction of the bursting element, the air bag is filled with the gas via the exit opening and/or the bypass region.

With the aid of a greatly simplified basic representation, FIG. 2 shows an exemplary embodiment of an air bag system 200 for a vehicle. Air bag system 200 includes an air bag 202 as well as a device 204 connected to air bag 202 for activating air bag 202. Air bag system 200 is installed in a vehicle 206, a passenger car in this case, in order, in the case of a collision of the vehicle 206, to protect a passenger 208, in this case a driver of the vehicle 206, from injuries caused by the collision. Device 204, in this case, is configured in the form of a cold gas generator, in which cold gas is stored under pressure and which, in the case of a collision of vehicle 206 permits the cold gas to flow into air bag 202, in order to fill the latter explosively and thus to intercept a forward movement of passenger 208 in a suitable manner and to decelerate it. In the representation in FIG. 2, air bag 202 is shown only for reasons of understanding, but generally, air bag 202 is not situated visibly in vehicle 206 before the beginning of the collision, for instance, it is integrated into the steering wheel of vehicle 206. As the representation in FIG. 2 shows, device 204 is connected to air bag 202 via an exit opening 210 and a bypass region 212, via which the cold gas is able to flow into air bag 202. The representation in FIG. 2 further shows a control unit 214, which is connected to device 204 via a lead system, for example. In the case of a collision of vehicle 206, device 204 receives an ignition signal 216 from control unit 214. Responding to ignition signal 216, a bursting disk is destroyed that is not shown in FIG. 2, which locks the cold gas in a pressure vessel of device 204, so that the cold gas is able to flow via exit opening 210 and/or bypass region 212 from device 204 into air bag 202, in order to inflate it suitably.

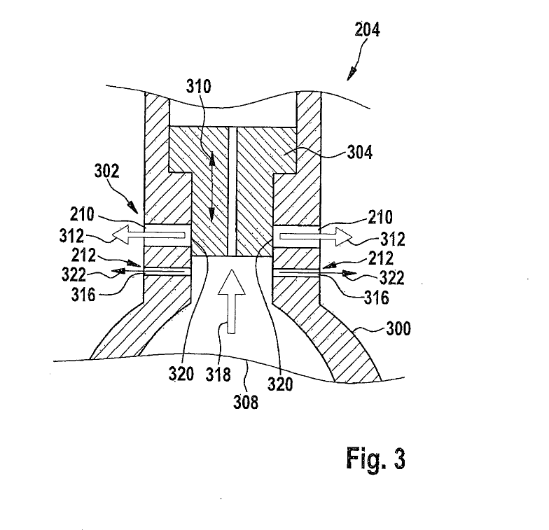

With the aid of a basic representation in a longitudinal section, FIG. 3 shows a cutout from the exemplary embodiment of device 204 shown in FIG. 2. What is shown in the end bit is a pressure vessel 300 for supplying a gas that is under pressure to fill up the air bag not shown here, that is connected to device 204. Pressure vessel 300 is formed to be cylindrical, in this case, and has a valve region 302 having a valve element 304 at a longitudinal extension end region. In valve region 302 there are two exit openings 210, situated opposite to each other, for letting out cold gas from pressure vessel 300 into the air bag that is connected to exit openings 210.

According to additional specific embodiments, device 204 may also have more or fewer exit openings 210. Valve region 302 may be formed in one piece with pressure vessel 300, or may include an originally separate valve, which in the production process of device 204 was connected to pressure vessel 300 in a gas-tight manner. Valve element 304 is configured as a piston, in this case, which is able to be actuated to move in valve region 302 between a resting position and a triggering position. In driving operation, pressure vessel 300 is closed gas-tight using a bursting element or a bursting disk 308. In the case of a collision, in response to an ignition signal emitted by the control unit to device 204, bursting disk 308 is destroyed, so that the gas is able to flow out of pressure vessel 300.

In the current functioning state of device 204 shown in FIG. 3, valve element 302 is in the resting position and closes exit openings 210 completely. In a motion 310 characterized by a double arrow, valve element 304 is able to be moved between the resting position and a triggering position, so as, in the case of the triggering of the air bag, to release exit openings 210 at least in phases, at least partially and to admit a first volume flow 312, characterized by arrows, of the gas out of pressure vessel 300 into the air bag.

In particular, FIG. 3 shows bypass region 212, which in the exemplary embodiment of the present invention of device 204, shown in the representation, is formed by two additional exit openings 316 in valve region 302. Bypass region 212 is connected upstream of an end region 320 of exit openings 210, in relation to a main flow direction 318, of first volume flow 312, that is characterized by an arrow. In the case of activation of the air bag, a second volume flow 322 of the gas, characterized by additional arrows, is able to flow from pressure vessel 300 into the air bag via bypass region 212. The second volume flow 322 is smaller than the first volume flow 312 and, in contrast to first volume flow 312, during the course of the collision, it flows continuously and independently of a functioning of valve element 304, and thus enables a complete emptying of pressure vessel 300, and a stabilization of the air bag volume at the same time.

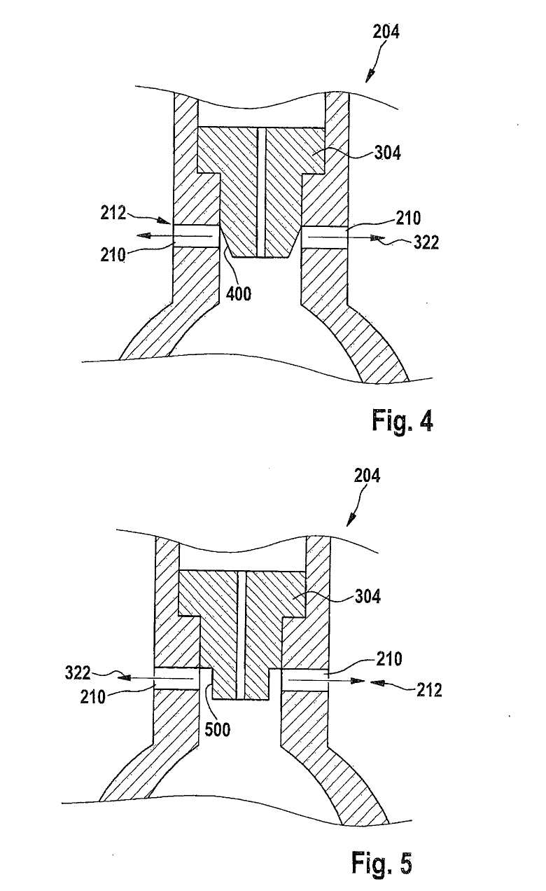

In the exemplary embodiment of device 204 shown in FIG. 3, the bypass function is ensured by separate outlets 316. In subsequent FIGS. 4 and 5, the bypass function is provided in valves, according to the servo principle, by tapering control piston 304.

Thus, with the aid of an additional basic representation in longitudinal section, FIG. 4 shows a cutout from an exemplary embodiment of device 204, in which bypass region 212 is implemented by a conical chamfer of valve element 304. As is shown by the representation in FIG. 4, valve element 304 has a tapered section 400 which, in the resting position of valve element 304 shown in FIG. 4, is located at the height of exit openings 210. Thus, exit openings 210 are partially opened even in the resting position of piston 304 and, even during a possible malfunction of valve 304 during activation of the air bag system, cold gas is able to flow, in the form of smaller second volume flow 322, into the air bag.

In turn, in longitudinal section, FIG. 5 shows a cutout from an exemplary embodiment of device 204, in which bypass region 212 is implemented by a step in valve element 304. In the exemplary embodiment shown in FIG. 5, valve element 304 has a gradation 500 lowering the cross section of valve element 304 which, in the resting position of valve element 304 shown in FIG. 5, is located at the height of exit openings 210. Consequently, this specific embodiment of gas generator 204 also makes possible the exit of the cold gas from exit openings 210 in the form of second volume flow 322 in case of a faulty functionality of valve element 304.

In general, the safety considerations on the air bag in travel operation have no difference between valve-controlled and conventional devices, because they are not activated during travel operation. In the case of a crash, faults are to be considered shortly after the ignition of the first stage, that is, after a few milliseconds, of cold gas generator 204 or of the actuation of cold gas generator 204 by the control unit. Faults may be present in the form of a plug connection interruption in the ignition circuit or in the form of a reset in the control unit. In these very rare cases, the pyrotechnic system is activated and. for example, fills the air bag with the gas created by the exothermic process. The second stage is no longer able to be ignited. With the elaboration of valve 304 by the bypass, after the course of a collision, e.g. after ca. 200 milliseconds, a complete emptying of pressure vessel 300 of gas generator 204 may be achieved, so that after the arrival of the rescue party there is no longer any danger. Thus, in spite of the fact that, in the cases described, a disposal ignition is no longer possible after 200 milliseconds, rescue of the passengers without danger is enabled. The disposal ignition is, so to speak, supplemented or completely replaced by the bypass, and is thus at an advantage over current systems which, in a fault case, are no longer able to carry out a disposal ignition. Using the bypass solution provided herein, safety is furthermore able to be increased in the extremely rare fault case, since at least one protective function may be assured, for instance, for a slim woman. This is equivalent to the protective function of the first step of a two-step air bag.

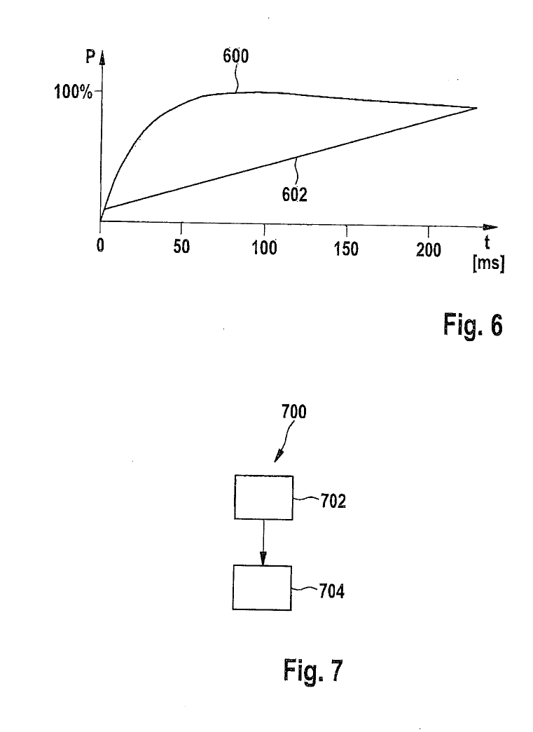

FIG. 6 shows a diagram representing a pressure curve in the can test of a device for activating an air bag for a vehicle, according to one exemplary embodiment of the present invention. A first graph 600 shows the pressure curve at a durably opened state of the valve of the device, and a second graph 602 shows the pressure curve at a durably closed state of the valve of the device. With these, one is clearly able to read out from the diagram, shown in FIG. 6, that at a durable valve opening, a maximum pressure is reached already after a short time after the opening, in this case after about 50 milliseconds, and then remains at this level. However, even in the case where the valve is not opened, a pressure increase is to be registered. This runs in a straight line and more slowly, but nevertheless reaches the same final value as with the durably opened valve.

FIG. 7 shows a flow chart of an exemplary embodiment of a method 700 for activating an air bag of a vehicle. Method 700 may be carried out by a device according to the present invention in accordance with one of the exemplary embodiments explained above, in connection with a control unit that is connected to the device. In a step 702, the control unit emits an ignition signal, via a suitable interface, to an apparatus for destroying the bursting element of the pressure vessel. The apparatus may be, for instance, a firing pellet situated on the bursting element. In a step 704, in response to the ignition signal, the bursting element is destroyed by the ignition of the firing pellet of the bursting element, so that gas is able to exit from the pressure vessel and flow via the at least one exit opening and/or the bypass region into the air bag, in order to activate it.

The invention provided herein, of a gas generator having valve control is demonstrable in a simple manner by componential analysis.

The exemplary embodiments described and shown in the figures have been selected merely as examples. Different exemplary embodiments are combinable with one another, either completely or with regard to individual features. An exemplary embodiment may also be supplemented by features from another exemplary embodiment.

Furthermore, method steps according to the present invention may be carried out repeatedly and also performed in a sequence other than the one described.

If an exemplary embodiment includes an “and/or” linkage between a first feature and a second feature, this may be understood to mean that the exemplary embodiment according to one specific embodiment has both the first feature and the second feature, and according to another specific embodiment, either has only the first feature or only the second feature.

What is claimed is:

1. A device for activating an air bag for a vehicle, comprising:
a pressure vessel for supplying a gas under pressure using at least one exit opening for letting out a first volume flow of the gas to the air bag;
a valve element connected to the pressure vessel, which is configured to close the exit opening at least partially in a resting position and, in a motion into a triggering position, to release the exit opening, a bursting element for the gas-tight closing of the pressure vessel; and
a bypass region for letting out a second volume flow of the gas to the air bag, wherein the bypass region is situated before an end region of the exit opening in relation to the main flow direction of the first volume flow.

2. The device of claim 1, wherein the bypass region is configured to have the effect that the second volume flow is less than the first volume flow.

3. The device of claim 1, wherein the bypass region is configured to have the effect that the second volume flow corresponds to an outlet volume flow of the gas through at least one disposal opening of the airbag for disposing of the gas from the air bag.

4. The device of claim 1, wherein the bypass region is formed by at least one additional exit opening in the pressure vessel, the distance of the additional exit opening from the bursting element being less than the distance of the valve element from the bursting element in the resting position of the valve element.

5. The device of claim 1, wherein the bypass region is formed by a tapered section of the valve element, the tapered section, in the resting position of the valve element, lying at essentially the same height as the exit opening.

6. The device of claim 1, wherein the bypass region is formed by a gradation of the valve element that reduces the cross section of the valve element, the gradation, in the resting position of the valve element, lying at essentially the same height as the exit opening.

7. An air bag system for a vehicle, comprising:
a device for activating an air bag for a vehicle, including:
a pressure vessel for supplying a gas under pressure using at least one exit opening for letting out a first volume flow of the gas to the air bag;
a valve element connected to the pressure vessel, which is configured to close the exit opening at least partially in a resting position and, in a motion into a triggering position, to release the exit opening, a bursting element for the gas-tight closing of the pressure vessel; and
a bypass region for letting out a second volume flow of the gas to the air bag, wherein the bypass region is situated before an end region of the exit opening in relation to the main flow direction of the first volume flow; and
an air bag connected to the device so that, based on a destruction of the bursting element, the air bag is filled with the gas via at least one of the exit opening and the bypass region.

8. A method for activating an air bag for a vehicle, the method comprising:
emitting an ignition signal for destroying a bursting element to fill the air bag with the gas via at least one of at least one exit opening and a bypass region;
wherein a device for activating the air bag includes:
a pressure vessel for supplying a gas under pressure using the at least one exit opening for letting out a first volume flow of the gas to the air bag;
a valve element connected to the pressure vessel, which is configured to close the exit opening at least partially in a resting position and, in a motion into a triggering position, to release the exit opening, the bursting element for the gas-tight closing of the pressure vessel; and
the bypass region for letting out a second volume flow of the gas to the air bag, wherein the bypass region is situated before an end region of the exit opening in relation to the main flow direction of the first volume flow.

9. A control unit, comprising:
at least one unit for activating an air bag for a vehicle by emitting an ignition signal for destroying a bursting element to fill the air bag with the gas via at least one of at least one exit opening and a bypass region;
wherein a device for activating the air bag includes:
a pressure vessel for supplying a gas under pressure using the at least one exit opening for letting out a first volume flow of the gas to the air bag;
a valve element connected to the pressure vessel, which is configured to close the exit opening at least partially in a resting position and, in a motion into a triggering position, to release the exit opening, the bursting element for the gas-tight closing of the pressure vessel; and
the bypass region for letting out a second volume flow of the gas to the air bag, wherein the bypass region is situated before an end region of the exit opening in relation to the main flow direction of the first volume flow.

10. A computer readable medium having a computer program, which is executable by a processor, comprising:
a program code arrangement having program code for activating an air bag for a vehicle, by performing the following:
emitting an ignition signal for destroying a bursting element to fill the air bag with the gas via at least one of at least one exit opening and a bypass region;
wherein a device for activating the air bag includes:
a pressure vessel for supplying a gas under pressure using the at least one exit opening for letting out a first volume flow of the gas to the air bag;
a valve element connected to the pressure vessel, which is configured to close the exit opening at least partially in a resting position and, in a motion into a triggering position, to release the exit opening, the bursting element for the gas-tight closing of the pressure vessel; and
the bypass region for letting out a second volume flow of the gas to the air bag, wherein the bypass region is situated before an end region of the exit opening in relation to the main flow direction of the first volume flow.
